(19) United States
(12) Patent Application Publication
(10) Pub. No.: US 2024/0300342 A1
(43) Pub. Date: Sep. 12, 2024

(54) WIRELESS CHARGING SYSTEM FOR LIGHT ELECTRIC VEHICLES

(71) Applicant: Solaires Entreprises Inc., Victotria (CA)

(72) Inventors: Mahshid Sam, Victoria (CA); Alfonso Fabian de la Fuente Sanchez, Victoria (CA)

(73) Assignee: Solaires Entreprises Inc., Victoria (CA)

(21) Appl. No.: 18/181,060

(22) Filed: Mar. 9, 2023

(51) Int. Cl. B60L 53/10; B60L 8/00; B60L 53/37; H02J 50/30; H02S 40/22

(52) U.S. Cl. CPC B60L 53/10; B60L 8/003; B60L 53/37; H02J 50/30; H02S 40/22

(57) ABSTRACT

A wireless charging system is provided for use with a light electric vehicle, the wireless charging system comprising: a receiver module for mounting on the light electric vehicle, the receiver module including a converging lens, which includes an inner surface, a solar module mounted proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is in electronic communication with the microcontroller and is one of a camera, a radio receiver or an audio receiver; and a signaller, which is one of a light source, a radio transmitter or an audio transmitter.

### FIELD

The present technology is directed to a wireless charging system that includes an artificial light source. More specifically, it is a combination of a solar collector which is mounted on a light electric vehicle and a remote photon emitter.

### BACKGROUND

Light electric Vehicles (LEV) have specialized charging stations located in parking areas. In order to charge their LEV, the drivers of the LEVs need to plug a charging cable to the LEV charge port. When the LEV is parked in a house, a specialized dedicated charging station or cable is supplied. People who park on streets overnight do not have access to a charging station. Wireless charging would make it possible for LEV users parking on streets to charge their LEVs remotely.

U.S. Pat. No. 5,811,958 discloses portable electric power source characterized by the fact an electric double layer battery is placed at a stage which follows a cell which generates electricity by receiving sunlight; and in which in order to produce current bit by bit from said electric double layer battery, the current capacity of said electric double layer battery is made smaller than the current capacity of a constant voltage secondary battery of a following stage; and which is further characterized by the fact that a DC-DC convertor is connected to the next stage, so that charging can be carried out at said constant voltage secondary battery even at an electric potential in which the output voltage of said electric double layer battery is lower than the voltage of the constant voltage secondary battery attached to the following stage. The portable electric power source device with attached battery charger of the present invention effectively allows more than 90% of consumer semiconductor devices or appliances typically used in the home to be powered by distribution management. This invention also makes possible long-term charging of the electrical power source of vehicles, supplying current and instantaneous pulse voltage, as is needed for automobile ignition. This is suitable only for use as a charger for an ignition battery and not for powering a light electric vehicle.

United States Patent Application Publication No. 20170141718 discloses An improved solar charger that may configured for direct coupling to a plurality of portable electronic devices. The improved solar charger is particularized to match or fall within intended electronic devices charging voltage and amperage requirements and contains a port identification mechanism to enable and facilitate “fast” charging modes without the use of an internal battery or ancillary electronic circuit boards. More specifically, the solar power charger incorporates a variety of features that make the design rugged, compact, waterproof, and durable. This is suitable only for use as a charger for small electronic devices and not for powering a light electric vehicle.

What is needed is a wireless charging system that includes an artificial light source that can be directed to a solar collector on an LEV. It would be preferable if the system also included a tracking system. It would be further preferable if the tracking system could both identify the LEV and locate the LEV. It would be further preferable if the artificial light source, under control of a computing unit, be directed to the solar collector of the LEV. It would be further preferable if a drive mechanism was under control of the computing unit to direct the artificial light source.

### SUMMARY

The present technology is a wireless charging system that includes an artificial light source that can be directed to a solar collector on an LEV. The system includes a tracking system. The tracking system can both identify the LEV and locate the LEV. The artificial light source, under control of a computing unit, can be directed to the solar collector of the LEV. This is effected by a drive mechanism which is under control of the computing unit.

In one embodiment, a wireless charging system is provided for use with a light electric vehicle, the wireless charging system comprising: a receiver module for mounting on the light electric vehicle, the receiver module including a converging lens, which includes an inner surface, a solar module mounted proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is in electronic communication with the microcontroller and is one of a camera, a radio receiver or an audio receiver; and a signaller, which is one of a light source, a radio transmitter or an audio transmitter.

In the wireless charging system, the artificial light source may be selected from the group consisting of one or more laser emitters, one or more light emitting diodes and one or more organic light emitting diodes.

In the wireless charging system, the artificial light source may be selected from the group consisting of an infrared light emitter, an ultraviolet light emitter, a visible light emitter and a broad-spectrum light emitter.

In the wireless charging system, the signaller may be integrated into the receiver module.

In the wireless charging system, the signaller may be proximate to the receiver module.

The wireless charging system may further comprise a remote sensor for locating in a parking stall, and a remote microcontroller which is in electronic communication with the remote sensor and the signaller.

In the wireless charging system, the remote sensor may be a force sensor.

In the wireless charging system, the remote sensor may be a light emitter and light detector pair.

In another embodiment a method of assembling a wireless charging system is provided for autonomously charging a light electric vehicle (LEV) battery wirelessly, in situ, the method comprising:
selecting a wireless charging system, the wireless charging system comprising: a receiver module, the receiver module including a converging lens, which includes an inner surface, a solar module proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is one of a camera, a radio receiver or an audio receiver, which is in electronic communication with the microcontroller; and a signaller, which is one of a light source, a radio transmitter or an audio transmitter;
mounting the receiver module on an upper, outer surface of the LEV;
connecting the electrical line to the LEV battery; and
mounting the remote emitter module on a surface within range of the receiver module, before or after mounting the receiver module.

In another embodiment, a method of autonomously charging a light electric vehicle (LEV) battery wirelessly, in situ, is provided, the method comprising:
parking an LEV within range of a remote emitter module, wherein the LEV includes a receiver module mounted on an outer, upper surface, the receiver module including a converging lens, a solar module between the outer, upper surface and the converging lens and an electrical line in electrical communication with the solar module and at least one LEV battery and wherein the remote emitter module includes an artificial light source, an actuator, which is in mechanical communication with the artificial light source, a microcontroller, which is in electronic communication with the actuator and a tracker, which is one of a camera, a radio receiver or an audio receiver, which is in electronic communication with the microcontroller; and a signaller, which is one of a light source, a radio transmitter or an audio transmitter;
the signaller sending signals;
the tracker locating the LEV from signals emitted by the signaller;
the tracker communicating with the microcontroller, which communicates with the actuator;
the actuator optimizing the position of the remote emitter module such that the artificial light source is directed to the receiver module; and
the solar module collecting light from the light source and sending power to the LEV battery, thereby charging the LEV battery in situ.

### BRIEF DESCRIPTION OF THE DRAWINGS

FIG. 1A is a block diagram of the wireless charging system for an LEV.

FIG. 1B is a block diagram of an alternative wireless charging system.

FIG. 2A is a side view of the technology of FIG. 1A, in use.

FIG. 2B is a side view of the alternative wireless charging system of FIG. 1B, in use.

FIG. 3 is a flow chart showing the operation of the wireless charging system.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,”“having,”“including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### DEFINITIONS

In situ—in the context of the present technology, in situ refers to the battery of the LEV being charged while in the LEV.

### DETAILED DESCRIPTION

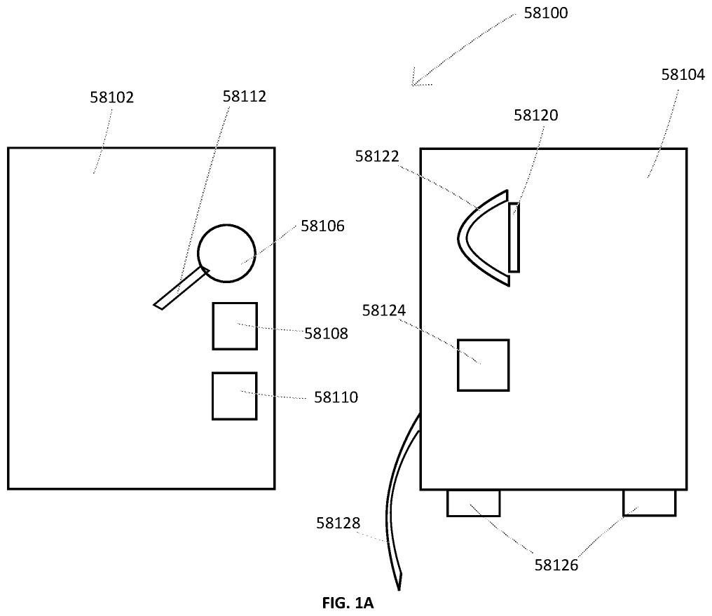

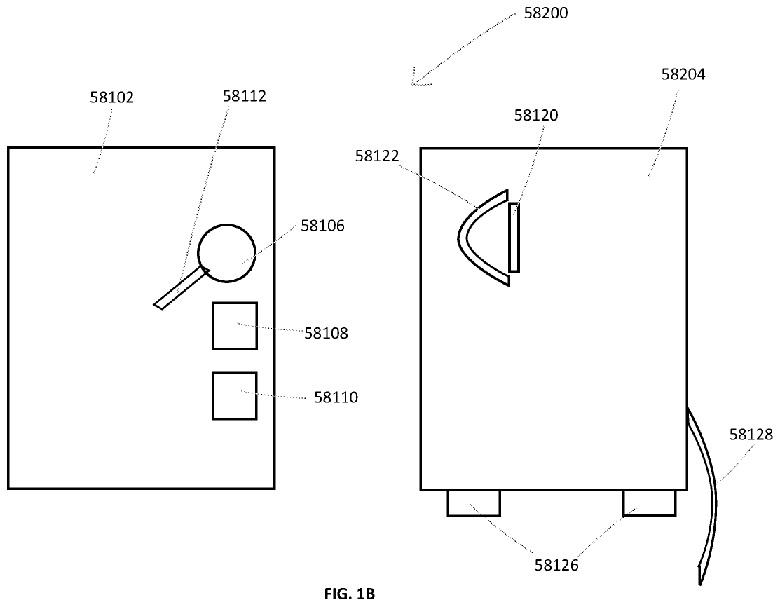

As shown in FIG. 1A, a block diagram of the wireless charging system, generally referred to as 58100, includes an emitter module 58102 and a receiver module 58104. The emitter module 58102 includes an artificial light source 58106, a tracker 58108, a printed circuit board or microcontroller 58110 and an actuator 58112.

The printed circuit board or microcontroller 58110 is in electronic communication with the tracker 58108 and the actuator 58112, and in turn, the actuator 58112 is in mechanical communication with the artificial light source 58106. The artificial light source 58106 may be, for example, but not limited to one or more laser emitters, one or more light emitting diodes or one or more organic light emitting diodes, which may be an infrared light emitter, an ultraviolet light emitter, a visible light emitter and a broad-spectrum light emitter. The emitter module 58102 is remote to the receiver module 58104. The receiver module 58104 includes a solar module 58120, a converging lens 58122, a signaller 58124, an attachment mechanism 58126 and an electrical connection 58128 for electrical communication with the LEV's battery. In an alternative embodiment, an adhesive may replace the attachment mechanism. In an alternative embodiment the signaller 58124 is proximate to the receiver module 58104 and is mounted separately on the roof of the LEV. In one embodiment, the converging lens 58122 is retained in a frame that also retains the solar module 58120. In another embodiment, the converging lens 58122 is a dome. The solar module 58120 in both embodiments is proximate to the inner surface of the converging lens 58122.

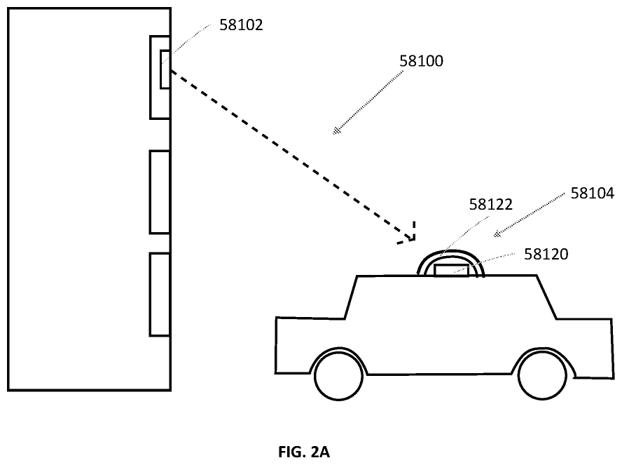

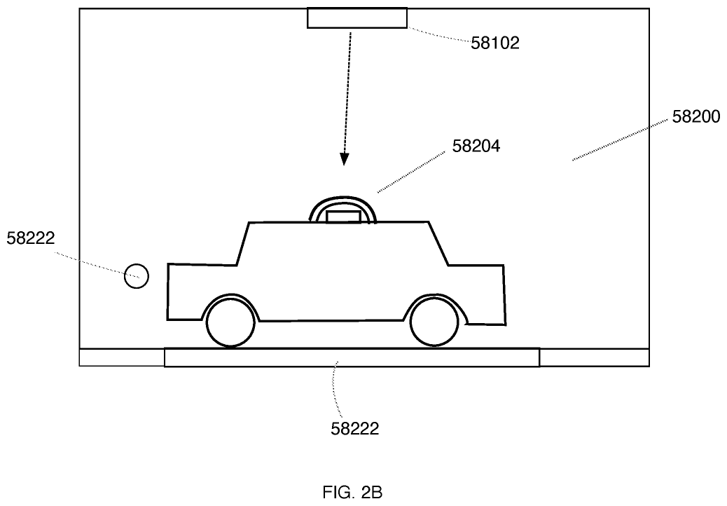

An alternative embodiment, generally referred to as 58200 for use in a parking garage is shown in FIG. 1B. The receiver module 58104 is replaced with receiver module 58204, which lacks the signaller 58124. Instead, there is a remote sensor 58222 (see FIG. 2B) which is located in the parking garage, proximate to the parking space or in the parking space. The remote sensor 58222 is in electronic communication with a signaller 58224, which is one of a light source that sends a specific, pre-set light frequency, a radio or an audio transmitter. In one embodiment, the remote sensor 58222 is a mechanical sensor, such as a force sensor, in the floor of the parking stall that senses the LEV. In yet another embodiment, the remote sensor 58222 is a light source and light detector in the parking garage, such that the light beam is broken when the LEV is parked in the parking space. A remote printed circuit board or microcontroller 58226 is in electronic communication with the remote sensor 58222 and the signaller 58224 and is configured to instruct the signaller 58224 when the remote sensor 58222 senses the LEV. One of an audio, radio or light signal is sent to the tracker 58108.

FIG. 2A is a side view of the wireless charging system 58100 in use. An LEV is shown with the receiver module 58104 mounted on the roof and a building is shown with the emitter module 58102 in a window.

FIG. 2B is a side view of the alternative embodiment wireless charging system 58200 in use. An LEV is shown with the receiver module 58204 mounted on the roof, the parking garage showing both the two remote sensors 58222, although only one need be employed and the ceiling of the parking garage having the emitter module 58102.

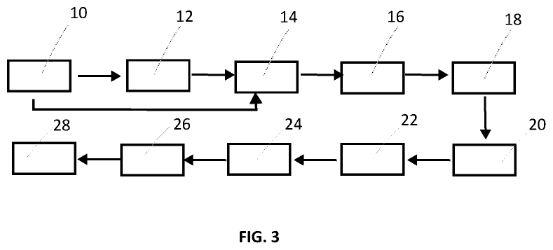

As shown in FIG. 3, an LEV parks 10 outside of a structure that retains the remote emitter module 58102. It is within range of the remote emitter module 58102. The LEV has a receiver module 58104, that includes the identifier, 58124 on its roof or other outer, upper surface. The signaller 58124 sends 12 a signal to the tracker 58108. In one embodiment, the signaller 58124 is a light source that sends a specific, pre-set light frequency and the tracker 58108 is a camera. In another embodiment, the signaller 58124 is a radio emitter and the tracker 58108 is a radio frequency receiver. In yet another embodiment, the signaller 58124 is an audio transmitter and the tracker 58108 is an audio receiver. In yet another embodiment, designed for use in parking garages, the mechanical sensor 58222 in the floor of the parking garage and the microcontroller 58226 replace the signaller 58124 and senses the LEV. One of an audio, radio or light signal is sent to the tracker 58108. In yet another embodiment, the identifier is replaced with the light source and light detector sensing system 58222 and the microcontroller 58226 in the parking garage, such that the light beam is broken when the LEV is parked in the parking space. One of an audio, radio or light signal is sent to the tracker 58108. In yet another embodiment, computer vision is used and the identifier does not need to send a signal, as the image of the vehicle is the image. Once the signal or image is in range, the tracker 58108 communicates 14 with the printed circuit board or microcontroller 58110, which communicates 16 with the actuator 58112. The actuator 58112 then moves 18 the artificial light source 58106. This results in positioning 20 of the light beam. The light beam converges 22 as it passes through the converging lens. The converging beam then strikes 24 the solar module 58120, generating 26 power which travels 28 to the LEV batteries via the electrical connection 58128. The steps after the LEV parks are conducted autonomously, in other words without the need for human intervention.

In an alternative embodiment the signaller 58124 and the tracker 58108 are transceivers, allowing for two-way communication. In this embodiment, the receiver module 58104 includes a printed circuit board or microprocessor 58130, which is in electronic communication with the batteries of the LEV and is configured to determine the charge level of the batteries, and to communicate the charge level via the signaller 58124 to the tracker 58108.

The method of assembling a wireless charging system for autonomously charging a light electric vehicle (LEV) battery wirelessly, in situ, is as follows:
selecting a wireless charging system, the wireless charging system comprising: a receiver module, the receiver module including a converging lens, which includes an inner surface, a solar module proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is one of a camera, a radio receiver or an audio receiver, which is in electronic communication with the microcontroller; and a signaller, which is one of a light source, a radio transmitter or an audio transmitter;
mounting the receiver module on an upper, outer surface of the LEV;
connecting the electrical line to the LEV battery; and
mounting the remote emitter module on a surface within range of the receiver module, before or after mounting the receiver module.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A wireless charging system for use with a light electric vehicle, the wireless charging system comprising: a receiver module for mounting on the light electric vehicle, the receiver module including a converging lens, which includes an inner surface, a solar module mounted proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is in electronic communication with the microcontroller and is one of a camera, a radio receiver or an audio receiver;
and a signaller, which is one of a light source, a radio transmitter or an audio transmitter.

2. The wireless charging system of claim 1, wherein the artificial light source is selected from the group consisting of one or more laser emitters, one or more light emitting diodes and one or more organic light emitting diodes.

3. The wireless charging system of claim 2, wherein the artificial light source is selected from the group consisting of an infrared light emitter, an ultraviolet light emitter, a visible light emitter and a broad-spectrum light emitter.

4. The wireless charging system of claim 3, wherein the signaller is integrated into the receiver module.

5. The wireless charging system of claim 3, wherein the signaller is proximate to the receiver module.

6. The wireless charging system of claim 3, further comprising a remote sensor for locating in a parking stall, and a remote microcontroller which is in electronic communication with the remote sensor and the signaller.

7. The wireless charging system of claim 6, wherein the remote sensor is a force sensor.

8. The wireless charging system of claim 6, wherein the remote sensor is a light emitter and light detector pair.

9. A method of assembling a wireless charging system for autonomously charging a light electric vehicle (LEV) battery wirelessly, in situ, the method comprising:
selecting a wireless charging system, the wireless charging system comprising: a receiver module, the receiver module including a converging lens, which includes an inner surface, a solar module proximate to the inner surface of the converging lens and an electrical line in electrical communication with the solar module; a remote emitter module, the remote emitter module including an artificial light source, an actuator, which is in mechanical communication with the artificial light source, a microcontroller, which is in electronic communication with the actuator and a tracker, which is one of a camera, a radio receiver or an audio receiver, which is in electronic communication with the microcontroller;
and a signaller, which is one of a light source, a radio transmitter or an audio transmitter;
mounting the receiver module on an upper, outer surface of the LEV;
connecting the electrical line to the LEV battery; and
mounting the remote emitter module on a surface within range of the receiver module, before or after mounting the receiver module.

10. A method of autonomously charging a light electric vehicle (LEV) battery wirelessly, in situ, the method comprising:
parking an LEV within range of a remote emitter module, wherein the LEV includes a receiver module mounted on an outer, upper surface, the receiver module including a converging lens, a solar module between the outer, upper surface and the converging lens and an electrical line in electrical communication with the solar module and at least one LEV battery and wherein the remote emitter module includes an artificial light source, an actuator, which is in mechanical communication with the artificial light source, a microcontroller, which is in electronic communication with the actuator and a tracker, which is one of a camera, a radio receiver or an audio receiver, which is in electronic communication with the microcontroller; and a signaller, which is one of a light source, a radio transmitter or an audio transmitter;
the signaller sending signals;
the tracker locating the LEV from signals emitted by the signaller;
the tracker communicating with the microcontroller, which communicates with the actuator;
the actuator optimizing the position of the remote emitter module such that the artificial light source is directed to the receiver module; and
the solar module collecting light from the light source and sending power to the LEV battery, thereby charging the LEV battery in situ.
